(19) United States
(12) Patent Application Publication
(10) Pub. No.: US 2014/0061208 A1
(43) Pub. Date: Mar. 6, 2014

(54) FLIP TOP KOOZIE

(71) Applicant: Ryan Boyd, San Antonio, TX (US)

(72) Inventor: Ryan Boyd, San Antonio, TX (US)

(21) Appl. No.: 13/597,946

(22) Filed: Aug. 29, 2012

(51) Int. Cl. A47J 41/00

(52) U.S. Cl. 220/592.17

(57) ABSTRACT

An insulated beverage container wrap is provided. It has a typically cylindrical body having an upper perimeter defining a substantially opened top, side walls, and a bottom wall defining a substantially closed bottom. A lid having a lower perimeter defining a substantially open bottom, a top wall defining a substantially closed top, and side walls is provided. A hinge connects side walls adjacent the lid of the lower perimeter and the body upper perimeter for allowing the lid to move between a substantially open position allowing access to a beverage contained within the body and a substantially covered position.

### FIELD OF THE INVENTION

Koozies (insulated beverage container wraps or container coolers), more particularly, a koozie with two parts, a body and a flip top hingedly attached to the body.

### BACKGROUND OF THE INVENTION

Koozies are insulated wraps for receiving a container. They are usually cylindrical and comprised of foam; neoprene rubber, polyester, open cell foam, plain foam, foam variants of neoprene, and have a height is somewhat less than the cylindrical container they receive, leaving an exposed top portion of the container so that one may easily drink from the beverage container. The prior art koozies typically snugly receive the container in a resilient foam body.

These prior art koozies typically prevent from the hand from warming the drink and also heat from the environment from warming the drink, but usually contain an exposed top portion.

### SUMMARY OF THE INVENTION

Applicant provides a koozie having a body configured to receive a majority of a cylindrical can and a top, pivotally attached to the body, which is configured to cover the portion of the can left exposed by the body. A hinge is provided to pivotally attach the lid to the body. The lid is moveable between a covered and uncovered position.

Applicant provides an insulated beverage container wrap comprising a body having an upper perimeter defining a substantially open top, side walls, and a bottom wall defining a substantially closed bottom. A lid is provided having a lower perimeter defining a substantially open lid bottom, a top wall defining a substantially closed top, and side walls. A hinge connects the side walls adjacent the lid lower perimeter and the body upper perimeter, for allowing the lid to move between a substantially open position (user has access to the container) and a substantially covered position (lid covering the container top).

Applicant's novel flip top koozie helps prevent, when in a covered position, heat transfer to or from the enclosed beverage container, prevent access by weather elements, insects, bees, and the like.

### BRIEF DESCRIPTION OF THE DRAWINGS

FIG. 1 is a perspective view of Applicant's koozie with the lid in an uncovered position.

FIG. 2 is a side elevational view of an embodiment of Applicant's design with the lid in a covered position covering a top of the container C.

FIG. 2A is a side elevational view of another embodiment of Applicant's koozie.

FIGS. 3A and 3B illustrate a method of manufacturing a koozie.

FIGS. 4 and 5 are side elevational illustrations of an embodiment of Applicant's device in the uncovered (FIG. 4) and covered (FIG. 5) position.

FIGS. 6 and 7 are planar detail views of an embodiment of Applicant's present invention made from a single sheet of configured insulating material, such as foam.

FIGS. 8A, 8B, and 8C are front, back, and cross-sectional views of an alternate embodiment of Applicant's koozie.

FIGS. 9A and 9B illustrate another embodiment of Applicant's koozie.

FIGS. 10A, 10B, and 10C illustrate front elevational, top and back elevational views of an embodiment of Applicant's koozie.

FIGS. 10D, 10E, and 10F illustrate elevational views of an alternate embodiment of Applicant's koozie.

FIGS. 11A, 11B, and 11C represent front, rear elevational, and side cutaway views of an alternate embodiment of that illustrated with respect to FIGS. 8A, 8B, and 8C.

### DETAILED DESCRIPTION OF THE PREFERRED EMBODIMENT

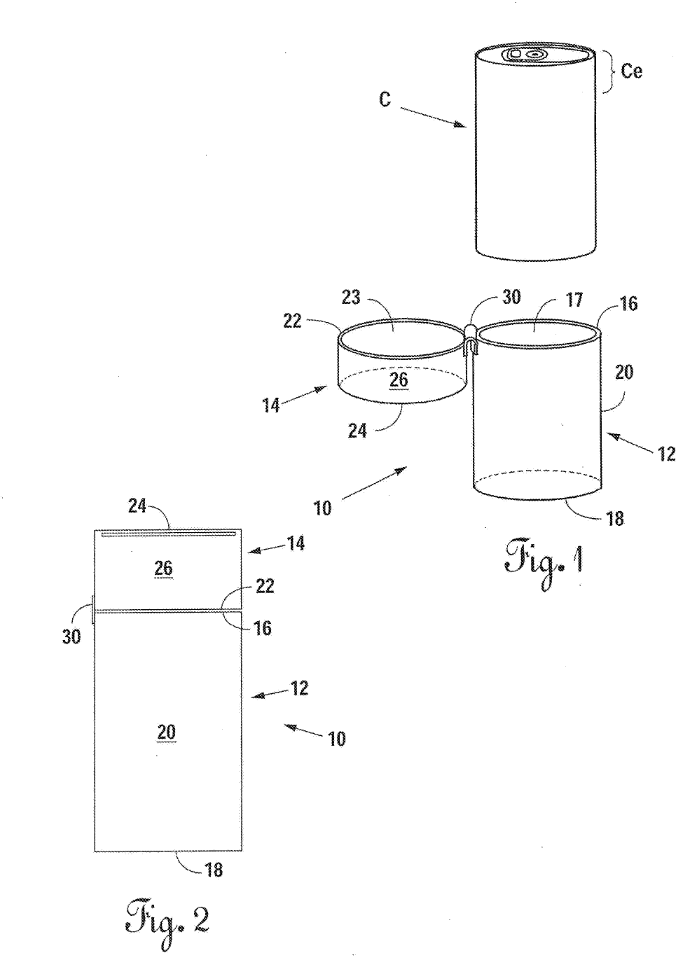

FIGS. 1 and 2 illustrate Applicant's flip top koozie 10. One embodiment comprises a cylindrical body 12 engaging a cylindrical lid 14 through a flexible hinge 30. In a preferred embodiment, at least body 12 and lid 14 made from a resilient, flexible foam insulating material or other suitable insulating material; neoprene rubber, polyester, open cell foam, plain foam, foam variants of neoprene.

Body 12 is seen to have an upper rim 16 defining a substantially open top 17, and a bottom wall 18 comprising, typically, a cylindrical material defining a substantially closed bottom. Side walls 20 substantially connect bottom wall 18 to upper rim 16. Upper rim 16 and body 12 are designed to receive, snugly, a container C, such as a twelve oz., sixteen oz. or twenty-four oz. aluminum drink container.

Lid 14 is dimensioned to cover the portion Ce of container C extending above upper rim 16 and may include a lower rim 22, defining an opening 23, which is dimensioned to snugly receive the upper portion of can C. Cylindrical side walls 26 and a substantially closed top wall 24 are provided.

As the materials comprising the body and lid are typically foam or other suitable material and somewhat stretchable or flexible, it is seen that in moving lid 14 from position in FIG. 1 to position in FIG. 2, there may be some stretching of lower rim 22 as it clears the upper rim of can C.

Hinge 30 may be any flexible material engaging in any suitable manner, such as by gluing, sewing or otherwise (including being a member integral to the material comprising the body and lid side wall). The hinge may be on the outer or inner walls in any other suitable position with respect to the upper areas of the side walls of the body and the lower areas of the side walls of the lid. Indeed, in one embodiment, a “one-piece” embodiment as described more specifically below, hinge 30 is not a separate piece, but is integral with the side walls 20/26.

In one embodiment, side walls 20 may be cylindrical and a separate cylindrical disc-shaped bottom portion, typically made of foam or other suitable flexible insulating material, may be provided and glued to the bottom perimeter of the side walls. Likewise, lid 14 may have separate side walls 26 with a separate disc-shaped top cut out and glued or otherwise affixed to the upper portion of side walls 26. Separate hinge 30 may be glued, sewn or otherwise affixed to flexibly engage body 12 to lid 14 (see FIGS. 1 and 2). FIG. 2A illustrates an embodiment with separate top/bottom 24/18, but hinge 30 is integral with the side walls 26/20.

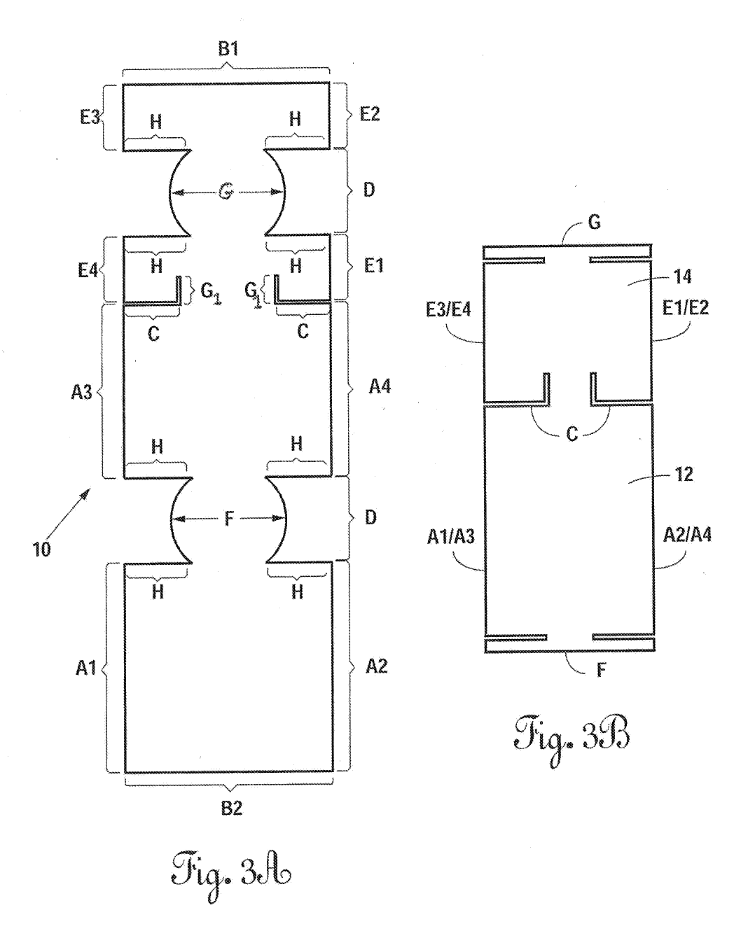

Typically, in one preferred embodiment, the lid has a height and the body has a height, and the lid height is about ⅓ or less (to about 1/10) than the total height of the lid and body together when the container is in the covered or closed position as seen in FIG. 5. Further, the body is dimensioned such that the container shows about ½ inch to an 2½ inch of “freeboard” or uncovered can when the lid is in the position as indicated in FIG. 4. In one preferred embodiment, the height of the lid and body in a closed position is about 4½ to 8½ inches and the diameter is about 2½ to 3 inches.

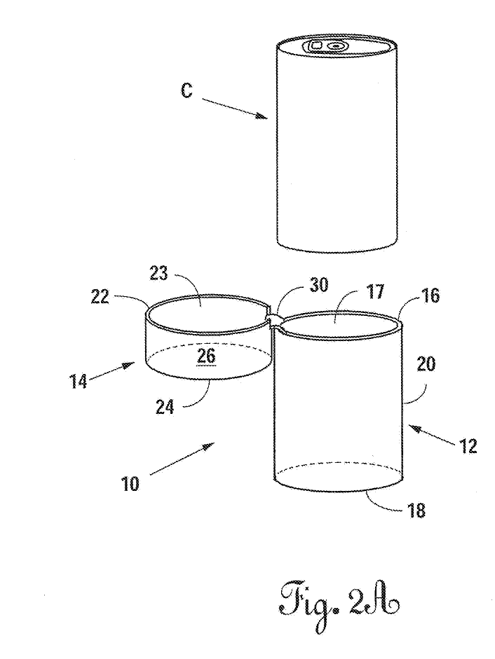

Although in the paragraphs set forth above it is seen that Applicant's lid and body may be made from separate parts glued or otherwise affixed together, Applicant also provides an alternate preferred method of manufacturing as seen, for example, with reference to FIGS. 3A and 3B. In FIG. 3A, a single sheet of flexible resilient insulated material, such as foam; neoprene rubber, polyester, open cell foam, plain foam, foam variants of neoprene, is seen laying flat. Two pairs of complementary opposed side wall edges of body are provided: A1/A3 and A2/A4. Likewise, two pairs of complementary opposed edges are provided for the lid side wall edges: E1/E2 and E3/E4. Dimensions G/F are also provided, shaped as indicated (roughly the diameter of the container). Dimensions C are side cuts that create separation between the lid and body laving the hinge. Specific dimensions are provided as dictated by the container for which koozie 10 is intended to cool.

After cutting out or otherwise forming the flat member illustrated in FIG. 3A, the body is formed by laying side wall edges A1 and A3 together and A2 and A4 together and sewing a seam along the two pairs. Likewise, E1 and E2 are laid together and E3 and E4 are laid together, and a third and fourth seam is sewn along the complementary edges. Cuts at C and G₁ have already been made for substantially separating the lid from the body (but leaving the hinge). After sewing or otherwise sealing the complementary edges, the top and bottom may, in one embodiment, place the seamed edges inside the body and lid, respectively. Ergo, a one-piece sheet yielding a flip top koozie. In another embodiment, seams are left “external.” Sewing is only one way of affixing the seam; gluing, heat sealing or any other suitable method may be used.

FIGS. 5 and 6 illustrate portions of Applicant's novel one-piece koozie seen in detail. FIG. 6 shows the top/bottom sections 24/18 appearing with slight perimeter cuts 34, which perimeter cuts are seen to have a somewhat arcuate shape and lay adjacent the top wall of the lid and the upper side walls of the lid, and adjacent the edges of the bottom wall and the bottom of the body side walls, and are typically formed in pairs.

FIGS. 2A, 4, 4A, and 7 illustrate hinge 30 formed integral with material of lid side walls and body side walls, and also the use of up cuts 32a/32b, which are cuts through the material and help allow pivoting of lid 14 between the covered and uncovered positions. The dimensions F and G are typically about (or slightly larger or slightly smaller) the diameter of the cylindrical beverage can that this koozie is intended to receive, Likewise, the sum of A2+E1 is approximately equal to or slightly larger than the height of the can that it is intended to enclose,

ONE PIECE TABLE
12 oz./16 oz./24 oz. Beverage Can

| | 12 oz. | 16 oz. | 24 oz. |
|---|---|---|---|
| A1, A2, A3, A4 | about 4″ | about 5″ | about 6″ |
| B1, B2 | about 4½″ | about 4½″ | about 4⅝″ |
| E1, E2, E3, E4 | about 1½:″ | about 1½″ | about 1½″ |
| C | about 1¼″ | about 1¼″ | about 1¼″ |
| D | about 2¼:″ | about 2¼″ | about 2¼″ |
| F G | about 2⅝″ | about 2⅝″ | about 2¾″ |
| G₁ | about ½″ | about ½″ | About ½″ |
| H | about 1⅝″ | about 1⅝″ | about 1⅝″ |
| +/− about ½″ | | | |

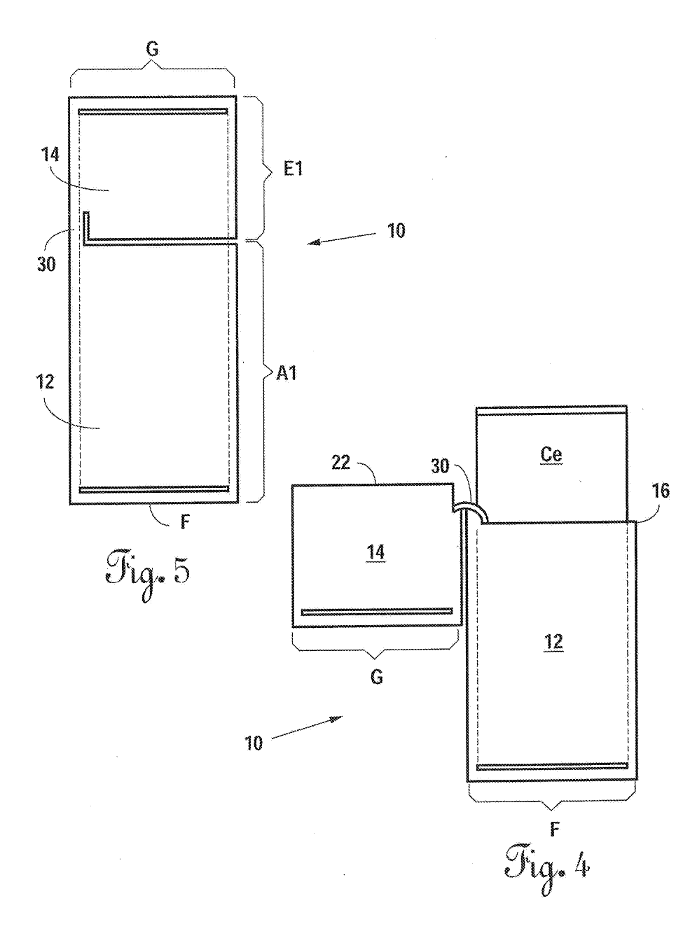

FIGS. 8A, 8B, and 8C illustrate another embodiment of Applicant's koozie. This embodiment body 12 is shaped to fit a container that is at least, in part, non-cylindrical. It may have a zipper 34 or other closeable opening (such as Velcro) through which the container can be inserted, which zipper 34 or other closeable opening helps snugly secure body 12 to the container. Lid 14 is pivoted with a hinge 30, which may be integral to the walls of the lid side walls or hinge 30 may be separate and attached to the lid and body by glue, sewing or other suitable means. Up cuts 32a/32b may be provided in either integral or separate hinge. Typically, in the embodiment illustrated, the container substantially enclosed within body 12 will have a neck with a screw cap. It is seen that lid 14 is dimensioned to fit over the neck and the cap may be either on or off (lid material having some resilience). Thus, in the embodiment illustrated in FIGS. 8A, 8B, and 8C, substantially all but the neck of a bottle or other non-cylindrical container is enclosed within the body 12 with lid 14 covering the neck/cap area.

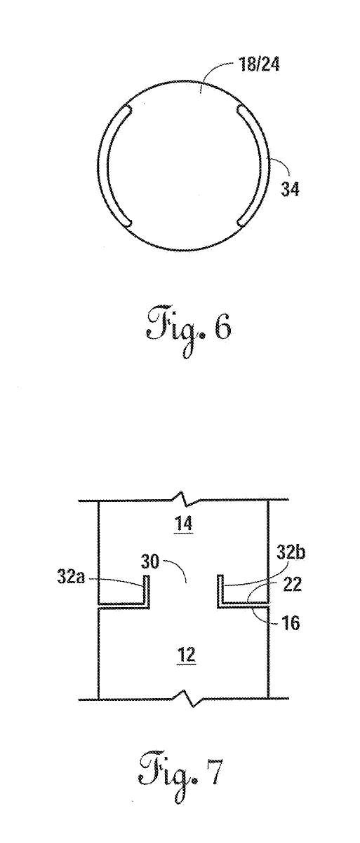

FIGS. 9A and 9B illustrate another embodiment of Applicant's koozie 10. However, there are no side walls to the lid and hinge 30 runs up to the cylindrical top 24, which is configured to substantially cover the top of the cylindrical can. A fabric strap 36 or other flexible element pivotally connects the lid 14 (with no side walls) to the upper side walls of body 12 through cooperating Velcro elements 38.

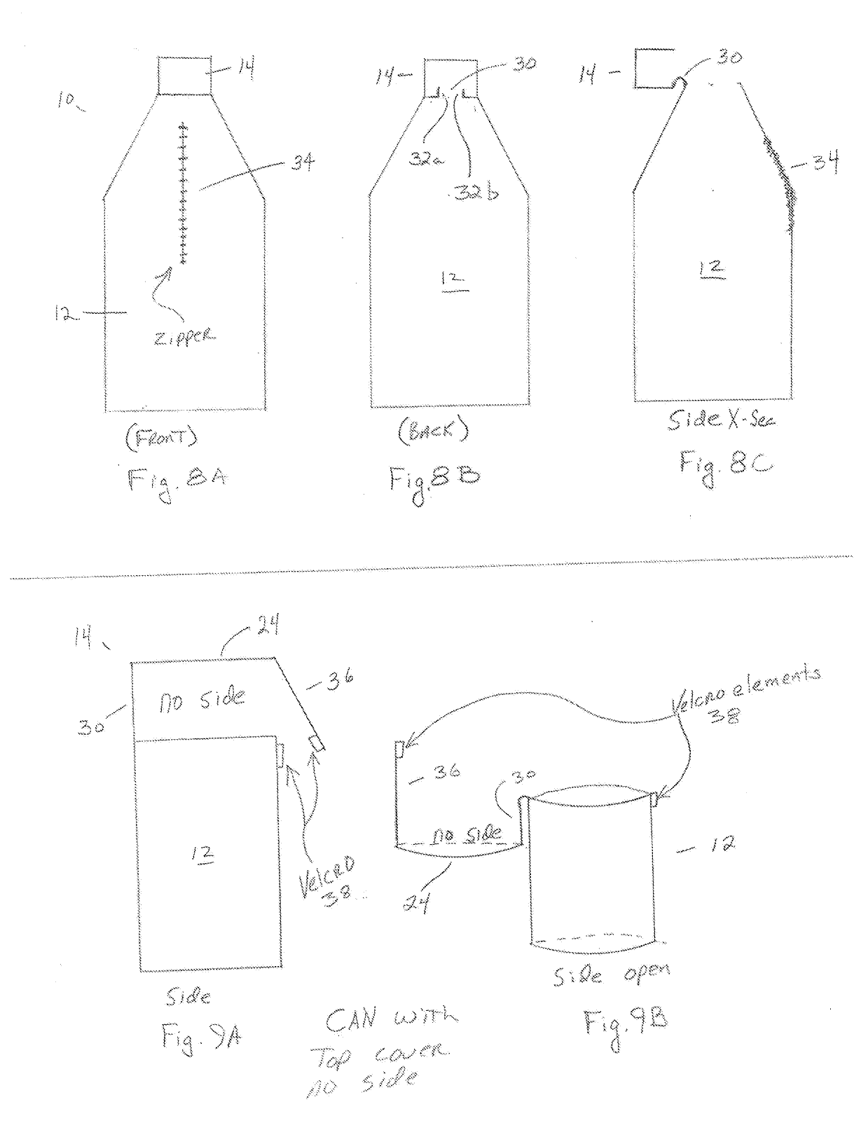

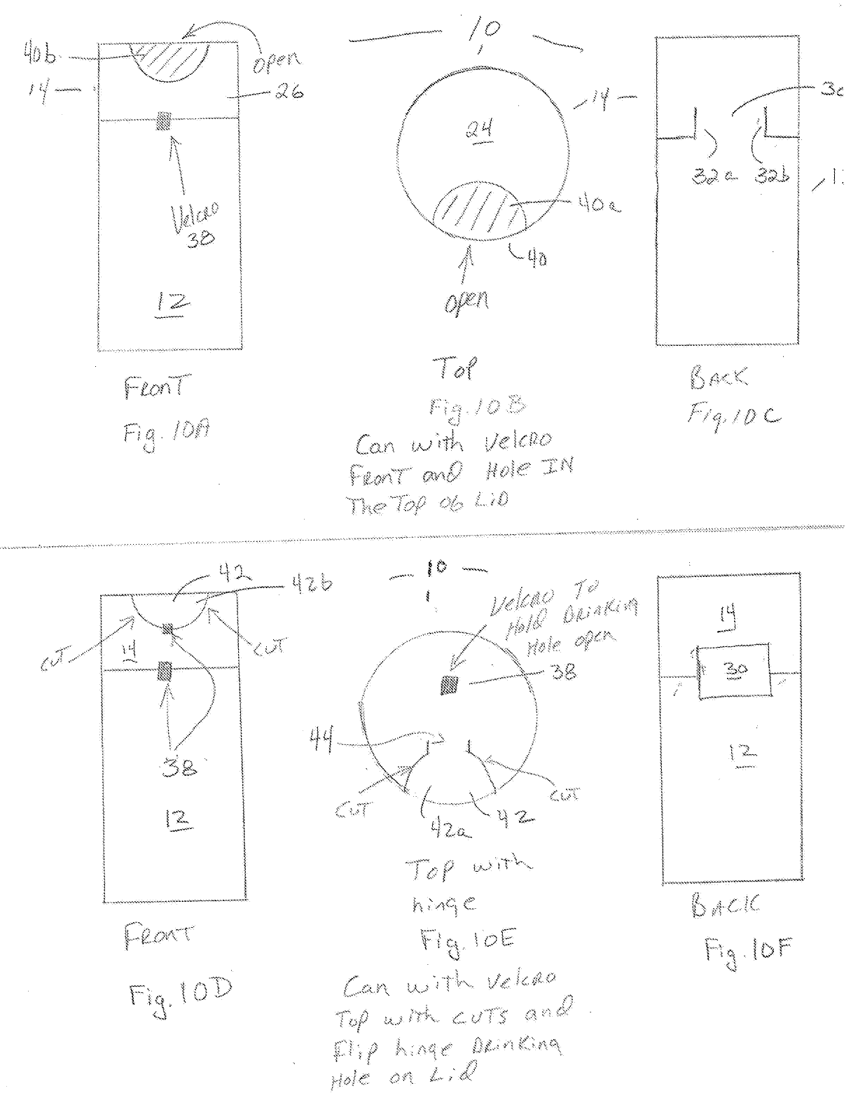

FIGS. 10A, 106, and 10C illustrate front elevational, top and back elevational views of an embodiment of Applicant's koozie 10. In this embodiment, it is seen that there may be a cutout 40 defined in the lid 14, which cutout is typically dimensioned to expose the opening of a cylindrical can so that the lid 14 may be maintained in a closed position as by a strap with cooperating Velcro elements 38, but the user can drink with the lid in a closed position. Cutout 40 may have a top cutout portion 40a and may have a side wall cutout portion 40b (see FIG. 10A). Typically, this embodiment has at least top cutout portion 40a.

FIGS. 10D, 10E, and 10F illustrate an alternate embodiment of Applicant's koozie 10 similar to the FIGS. 10A, 10B, and 10C embodiment, except that lid 14 itself contains a pivoting hinged container hole covering member 42 having hinge 44 to cover and uncover cutout 40 (see FIG. 10A). A strap with cooperating Velcro elements 38 may hold lid 14 to body 12 and may also hold hole covering member 42 in an opened (for drinking) or closed (to prevent heat transfer) position, Hole covering member 42 may have portion 42a, which will be configured to uncover a drink hole in the beverage container, and portion 42b to uncover a portion of the can side wall configured so a user's lips do not touch the koozie.

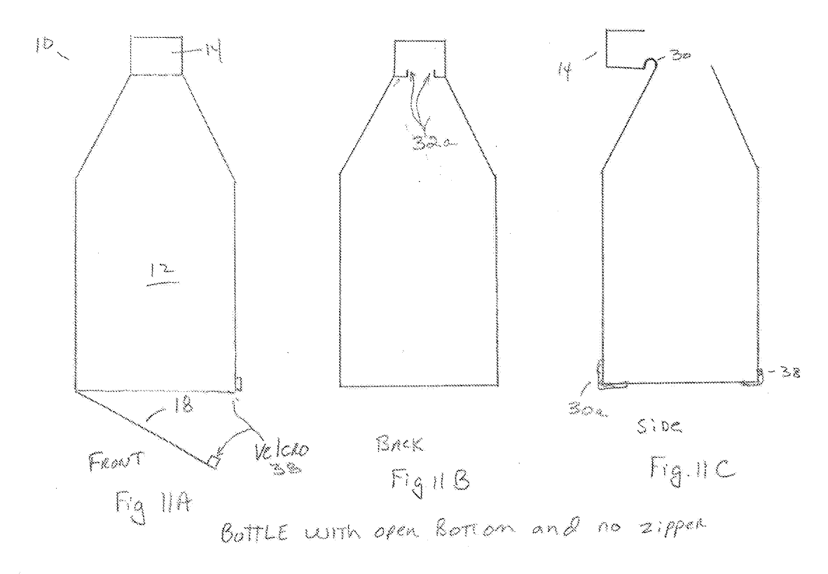

FIGS. 11A, 11B, and 11C represent front, rear, and side cutaway views of an alternate embodiment of that illustrated with respect to FIGS. 8A, 88, and 8C. The main difference is that, instead of a zipper 34 or other opening, bottom wall 18 is hinged to lower side walls of body 12 where a hinge 30a, which opens the bottom end allowing a bottle to be inserted up and into body 12. Strap and Velcro elements 38 allow hinged bottom wall to be pivotally affixed to the body side walls.

Although the invention has been described with reference to a specific embodiment, this description is not meant to be construed in a limiting sense. On the contrary, various modifications of the disclosed embodiments will become apparent to those skilled in the art upon reference to the description of the invention. It is therefore contemplated that the appended claims will cover such modifications, alternatives, and equivalents that fall within the true spirit and scope of the invention.

1. An insulated beverage container comprising:
a body having an upper perimeter defining a substantially open top, side walls, and a bottom wall defining a substantially closed bottom;
a lid having a lower perimeter defining a substantially open lid bottom, a top wall defining a substantially closed top, and side walls; and
a hinge connecting side walls adjacent the lid lower perimeter and the body upper perimeter, for allowing the lid to move between a substantially open position and a substantially covered position.

2. The insulated beverage container of claim 1, wherein the body and lid are at least partially made of resilient foam.

3. The insulated beverage container of claim 1, wherein the body and lid are made of foam: neoprene rubber, polyester, open cell foam, plain foam, foam variants of neoprene.

4. The insulated beverage container of claim 1, wherein the hinge includes up cuts.

5. The insulated beverage container of claim 1, wherein the body and lid are cylindrical.

6. The insulated beverage container of claim 1, wherein the lid has a height and the body has a height and wherein the lid height is about ⅓ or less of the total height of the lid and body height.

7. The insulated beverage container of claim 1, wherein the height of the body is dimensioned to have about ½ inch to 2½ inches of container exposed when the lid is in the uncovered position.

8. The insulated beverage container of claim 1, wherein the body and lid are at least partially made of resilient foam; wherein the body and lid are cylindrical; and wherein the lid has a height and the body has a height and wherein the lid height is about ⅓ or less of the total height of the lid and body height.

9. The insulated beverage container of claim 8, wherein the height of the lid and body in the closed position is about 4½ to 8½ inches and the diameter is about 2½ to 3 inches.

10. The insulated beverage container of claim 9, wherein the lid further includes a pair of cuts in the side walls adjacent the hinge.

11. The insulated beverage container of claim 1, wherein the body, lid, and hinge are configured to be formed from a single sheet of material.

12. The insulated beverage container of claim 11, wherein the single sheet is either neoprene or open cell foam.

13. The insulated beverage container of claim 11, wherein the lid further includes a pair of upcuts.

14. The insulated beverage container of claim 11, wherein the lid contains an opening at least partly in the top wall configured to expose a drink, opening in the beverage container.

15. The insulated beverage container of claim 11, wherein the lid includes a covering hinged member adapted to cover and uncover the configured opening.

16. An insulated beverage container wrap comprising:
a body having an upper perimeter defining a substantially open top, side walls, and a bottom wall defining a substantially closed bottom;
a lid having a lower perimeter defining a substantially open lid bottom, a top wall defining a substantially closed top, and side walls; and
a hinge connecting side walls adjacent the lid lower perimeter and the body upper perimeter, for allowing the lid to move between a substantially open position and a substantially covered position;
wherein the body and lid are at least partially made of resilient foam;
wherein the hinge includes up cuts;
wherein the body and lid are cylindrical;
wherein the lid has a height and the body has a height and wherein the lid height is about ⅓ or less of the total height of the lid and body height; and
wherein the height of the lid and body in the closed position is about 4½ to 8½ inches and the diameter is about 2½ to 3 inches.

17. An assembly comprising:
a 12 oz., 16 oz. or 24 oz. beverage can; and
a koozie comprising a body having an upper perimeter defining a substantially open top, side walls, and a bottom wall defining a substantially closed bottom; a lid having a lower perimeter defining a substantially open lid bottom, a top wall defining a substantially closed top, and side walls; and
a hinge connecting side walls adjacent the lower perimeter of the lid and the upper perimeter of the body, for allowing the lid to move between a substantially open position and a substantially covered position, wherein the body and lid are at least partially made of resilient foam;
wherein the body and lid are cylindrical; and wherein the lid has a height and the body has a height and wherein the lid height is about ⅓ or less of the total height of the lid and body height, and wherein the height of the lid and body in the closed position is about 4½ to 8½ inches and the diameter is about 2½ to 3 inches; and
wherein the lid further includes a pair of cuts in the side walls adjacent the hinge.

18. A method of manufacturing a beverage container wrap, the method comprising the steps of:
providing a single sheet of flexible, resilient, insulating material with two pairs of complementary opposing body side wall edges and two pairs of complementary opposing lid side wall edges;
connecting the complementary opposing side wall/pairs of the body; and
connecting the complementary opposing side wall/pairs of the lid.

19. The method of claim 18, further including turning the lid inside out and turning the body inside out.

20. A device for insulating a beverage container, the device comprising:
a body comprising an insulating material, the body configured to substantially enclose the beverage container; and
a pivotal member pivotally engaged to the body for engaging the body, the pivotable member movable between a covered position in which it covers at least the drink opening of the beverage container and an uncovered position, allowing access to the drink opening.
